(19) United States
(12) Patent Application Publication
(10) Pub. No.: US 2008/0083499 A1
(43) Pub. Date: Apr. 10, 2008

(54) Process for Production and Apparatus for Production of Laminate

(75) Inventor: Mitsunori Nodono, Ibaraki (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/665,371

(22) PCT Filed: Oct. 19, 2005
(86) PCT No.: PCT/JP05/19640

§ 371 Date: Jun. 22, 2007

(30) Foreign Application Priority Data
Oct. 21, 2004 (JP) 2004-307247

(51) Int. Cl. B32B 37/12

(52) U.S. Cl. 156/324; 156/578

(57) ABSTRACT

A process for production of a laminate in which creasing is suppressed. The process for production of a laminate of the invention comprise a coating step for coating a porous membrane 1 with a coating liquid, and a laminating step for moving the porous membrane 1 coated with the coating liquid along the circumferential surface of a feed roller 14, moving the porous membrane 1 coated with the coating liquid along the circumferential surface of a lamination roller 30 together with a supporting substrate 2, and laminating the porous membrane 1 coated with the coating liquid and the supporting substrate 2 to obtain a laminate 3a,

wherein assuming the radius of the feed roller 14 is R1 (cm), the radius of the lamination roller 30 is R2 (cm), the distance between the central axes of the feed roller 14 and the lamination roller 30 is L (cm), the thickness of the porous membrane 1 is T1 (cm), and the thickness of the supporting substrate 2 is T2 (cm), a condition represented by the following expression (1) is satisfied.
R1+R2+T1+T2≦L≦R1+R2+100 (1)

### TECHNICAL FIELD

The invention relates to a process for production and an apparatus for production of a laminate, and more particularly to a process for production and an apparatus for production of a laminate of a porous membrane and a supporting substrate having a solution containing a filler impregnated in voids.

### BACKGROUND ART

A fuel cell using a proton conductive polymer membrane as an electrolyte membrane (solid polymer electrolyte type fuel cell) is characterized by low temperature operation, high output density, and the possibility of miniaturization, and is expected to be useful as a power source for automobiles. Therefore, it is intensively researched and developed.

To provide the polymer electrolyte membrane with mechanical strength, durability and the like, a process is proposed for producing a polymer electrolyte membrane by impregnating the voids of a porous membrane with a polymer electrolyte (see, for example, Japanese Patent Application Laid-Open (JP-A) No. 6-29032).

To impregnate the voids of a porous membrane with a polymer electrolyte, a method is proposed for applying a polymer electrolyte solution to a porous membrane of a laminate consisting of a supporting substrate and a porous membrane, and drying the membrane (see, for examples JP-A No. 8-329962).

### DISCLOSURE OF THE INVENTION

However, when a polymer electrolyte solution is applied to a porous membrane of a laminate, the porous membrane may be swollen or loosened, and the obtained laminate, in particular, the porous membrane may be creased, and the appearance of the laminate may be spoiled. The inventor has discovered that the porous membrane is creased not only when a solution of a polymer electrolyte is applied to the porous membrane, but also when other liquids are applied to the porous membrane.

In the light of the above problems, it is hence an object of the invention to present a process for production and an apparatus for production of a laminate capable of suppressing creasing.

The inventor has intensively studied about a method of forming a laminate by laminating a supporting substrate and a porous membrane coated with a liquid, by moving a porous membrane coated with a liquid containing a filler along the circumferential surface of a feed roller, laminating with a supporting substrate, and moving along the circumferential surface of a lamination roller.

That is, the process for production of the invention includes a coating step for coating a porous membrane with a liquid containing a filler, and a laminating step for moving the porous membrane coated with the liquid along the circumferential surface of a feed roller, moving the porous membrane coated with the liquid along the circumferential surface of a lamination roller together with a supporting substrate, and laminating the porous membrane coated with the liquid and the supporting substrate to obtain a laminate, in which assuming the radius of the feed roller is R1 (cm), the radius of the lamination roller is R2 (cm), the distance between the central axes of the feed roller and the lamination roller is L (cm), the thickness of the porous membrane is T1 (cm), and the thickness of the supporting substrate is T2 (cm), a condition represented by the following expression (1) is satisfied.
R1+R2+T1+T2≦L≦R1+R2+100 (1)

The apparatus for production of a laminate of the invention includes a coating means for coating a porous membrane with a liquid containing a filler, a feed roller for moving the porous membrane coated with the liquid along the circumferential surface, and

a lamination roller for moving the porous membrane after moving along the circumferential surface of the feed roller along the circumferential surface together with a supporting substrate, and laminating the porous membrane coated with the liquid and the supporting substrate to obtain a laminate, in which assuming the radius of the feed roller is R1 (cm), the radius of the lamination roller is R2 (cm), the distance between the central axes of the feed roller and the lamination roller is L (cm), the thickness of the porous membrane is T1 (cm), and the thickness of the supporting substrate is T2 (cm), a condition represented by the following expression (1) is satisfied.
R1+R2+T1+T2≦L≦R1+R2+100 (1)

According to the invention, since the distance between the feed roller and the lamination roller is sufficiently short, the porous membrane coated with the liquid is hardly loosened between the two rollers before laminated with the supporting substrate. In this state, the porous membrane coated with the liquid is laminated with the supporting substrate by the lamination roller, creasing of the porous membrane of the obtained laminate is suppressed, and a laminate of an excellent appearance is obtained. In particular, the upper limit of L is preferably R1+R2+25, and more preferably R1+R2+15.

The liquid containing a filler (hereinafter, it may be optionally called a “coating liquid”) applied on the porous membrane is not particularly limited. For example, the liquid containing a filler may be a liquid of a filler for filling the voids of the porous membrane dissolved in a solvent, a slurry of a filler for filling the voids of the porous membrane dispersed in a liquid as solid particles, or the like. When the porous membrane impregnated with a filler is used in a fuel cell or similar applications, by using a liquid containing a polymer electrolyte as a filler, a polymer electrolyte membrane having voids of the porous membrane filled with the polymer electrolyte is obtained.

In the process of the invention, in the laminating step, it is preferred to form a laminate so that the porous membrane coated with the liquid, rather than the supporting substrate, may come to the outer side on the circumferential surface of the lamination roller.

In the apparatus of the invention, too, it is preferred to form a laminate so that the porous membrane coated with the liquid, rather than the supporting substrate, may come to the outer side on the circumferential surface of the lamination roller.

As a result, the laminate having the supporting substrate positioned at the inner side moves on the circumferential surface of the lamination roller, and the porous membrane is particularly extended in the circumferential direction of the lamination roller on the circumferential surface of the lamination roller, so that the suppressing effect of creasing of the porous membrane is further enhanced.

More preferably, the central angle A1 (degrees) of an arc contacting with the lamination roller and the laminate should satisfy a condition represented by the following expression (2).
10≦A1≦180 (2)

When the condition of (2) is satisfied, on the lamination roller, the laminate is sufficiently pushed against the circumferential surface of the lamination roller. As a result, the porous membrane is sufficiently extended in the conveying direction, and creasing of the porous membrane is much decreased. A particularly preferable range of A1 is 30≦A1≦150.

When the central angle A1 of the contacting arc of the lamination roller and the laminate is smaller than 10 degrees, the laminate is not pressed sufficiently against the lamination roller, and the decreasing effect of creasing of the porous membrane tends to be smaller, or when the central angle A1 exceeds 180 degrees, the porous membrane is extended excessively, and the decreasing effect of creasing of the porous membrane after passing the lamination roller tends to be smaller.

In the process of the invention, the laminating step is preferably further followed by a conveying step for moving the laminate along the circumferential surface of the conveying roller so that the porous membrane may come to the outer side rather than the supporting substrate.

In the apparatus of the invention, preferably, the apparatus further includes a conveying roller for moving the laminate formed by the lamination roller along the circumferential surface so that the porous membrane may come to the outer side rather than the supporting substrate.

Accordingly, on the conveying roller, since the laminate having the supporting substrate positioned at the inner side moves along the circumferential surface of the conveying roller, the porous membrane is further extended in the circumferential direction of the conveying roller on the circumferential surface of the conveying roller, and the decreasing effect of creasing of the porous membrane is further enhanced. Even if the porous membrane is swollen by impregnating the liquid, the decreasing effect of creasing is also high.

Such a conveying roller or a conveying step may be provided in plurality, and in such a case it is preferred to convey before the drying step for drying the applied liquid, or during the drying step.

Herein, the central angle A2 (degrees) of an arc contacting with the conveying roller and the laminate should satisfy a condition represented by the following expression (3).
10≦A2≦180 (3)

When the condition of (3) is satisfied, the laminate is sufficiently pushed against the conveying roller. As a result, the porous membrane is sufficiently extended in the conveying direction on the conveying roller, and creasing of the porous membrane is much more decreased. A particularly preferable range of A2 is 30≦A2≦150.

When the central angle A2 of the contacting arc of the conveying roller and the laminate is smaller than 10 degrees, the laminate is not pressed sufficiently against the conveying roller, and the decreasing effect of creasing of the porous membrane tends to be smaller, or when the central angle A2 exceeds 180 degrees, the porous membrane is extended excessively, and the decreasing effect of creasing of the porous membrane after passing the lamination roller tends to be smaller.

In the process of the invention, in the coating step and the laminating step, it is preferred to apply a tension F (kg/cm) satisfying a condition represented by the following expression (4) to the porous membrane in its conveying direction.

The apparatus of the invention, preferably, further includes a tension applying means for applying a tension F (kg/cm) satisfying a condition represented by the following expression (4) to the porous membrane in its conveying direction.
0.01≦F≦10 (4)

When a porous membrane coated with a liquid is pulled in the conveying direction by a tension satisfying the condition of the expression (4), creasing may be further suppressed when laminating with the supporting substrate.

When the tension F working in the conveying direction of the porous membrane is smaller than 0.01 kg/cm, the decreasing effect of creasing may be smaller, and when exceeding 10 kg/cm, the porous membrane is likely to be broken.

The invention is further preferred to include a drying step or a drying means for drying the applied liquid, and is hence preferably applied to mass production of laminates dried after being impregnated with a filler in voids of a porous body.

### BRIEF DESCRIPTION OF THE DRAWINGS

FIG. 1 is a schematic diagram of an apparatus for production of a laminate in a first embodiment of the invention, and is a first conveying route diagram in the apparatus for production.

FIG. 2 is a partially magnified view of the apparatus for production of a laminate in the first embodiment of the invention.

FIG. 3 is a schematic diagram of the apparatus for production of a laminate in the first embodiment of the invention, and is a second conveying route diagram in the apparatus for production.

FIG. 4(a) is a cross-sectional view of laminates 3a, 3b in FIG. 1, and FIG. 4(b) is a schematic sectional view of laminates 3d, 3e in FIG. 3.

FIG. 5 is a schematic diagram of an apparatus for production of a laminate in a second embodiment of the invention.

### DESCRIPTION OF REFERENCE NUMERALS

1 Porous membrane
1c Coated side
1d Opposite side (non-coated side)
2 Supporting substrate
3a, 3b, 3d, 3e, 3f Laminate
10 Feeder (tension applying means)
13 Horizontal roller (feed roller)
14 Feed roller
30 Lamination roller
31 Guide roller (conveying roller)
40 Drying unit (drying means)
50 Gravure coater
52 Pan
60 Slot die (coating means)
61 Slot die
70 Coating liquid (e.g. polymer electrolyte solution)
100, 200 Apparatus for production of laminate

### PREFERABLE MODE FOR CARRYING OUT THE INVENTION

Referring now to the drawings, preferred embodiments of the invention are specifically described below. Throughout the drawings, same elements are identified with same reference numerals, and duplicate explanations are omitted. Positional relations, such as upper and lower, and right and left are based on the configuration in the diagrams unless otherwise specified. The ratio of dimensions in the drawings is not limited to the shown ratio.

### First Embodiment

(Apparatus for Production of Laminate)

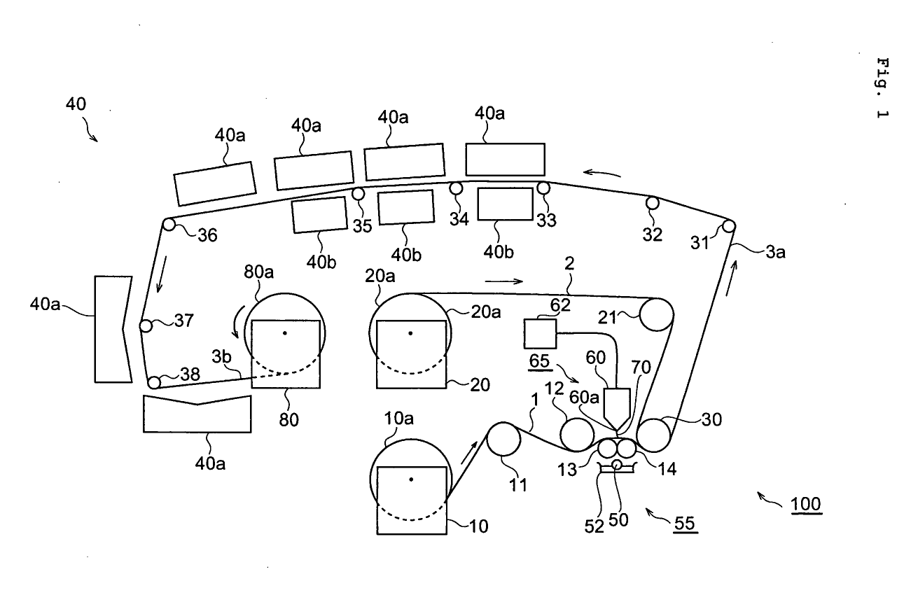

FIG. 1 to FIG. 3 are schematic diagrams of apparatus 100 for production of laminates in the embodiment.

This apparatus 100 for production is an apparatus for applying a coating liquid (for example, a liquid containing a polymer electrolyte) 70 on one side of a flexible porous membrane 1, laminating this porous membrane 1 and a flexible supporting substrate 2 by means of a lamination roller 30 to form a laminate 3a, drying this laminate 3a, and producing a laminate 3b as a laminated composite membrane of the supporting substrate and the porous membrane impregnated with a polymer electrolyte, continuously.

The apparatus 100 for production mainly includes, as shown in FIG. 1, a feeder 10 for feeding a porous membrane 1, a feeder 20 for feeding a supporting substrate 2, a first coating unit 65 for coating the porous membrane 1 supplied from the feeder 10 with a coating liquid 70, a lamination roller 30 for laminating the porous membrane 1 coated with the coating liquid 70 and the supporting substrate 2 supplied from the feeder 20 to form a laminate 3a, a drying unit 40 for drying the laminate 3a to obtain a laminate 3b, a take-up machine 80 for winding up the laminate 3b, and guide rollers 31 to 38 for guiding the laminate 3a or 3b from the lamination roller 30 to the take-up machine 80 by way of the drying unit 40.

The feeder 20 has a bobbin 20a on which the supporting substrate 2 is taken up, and by rotating this bobbin 20a, the supporting substrate 2 can be supplied. The supporting substrate 2 supplied from the feeder 20 is guided by the guide roller 21, and is supplied into the lamination roller 30.

The feeder 10 may also have a bobbin 10a on which the porous membrane 1 is taken up, and by rotating this bobbin 10a, the porous membrane 1 can be supplied. The porous membrane 1 ejected out from the feeder 10 is guided by the guide rollers 11, 12, passes through the first coating unit 65, and is laminated with the supporting substrate 2, and supplied into the lamination roller 30.

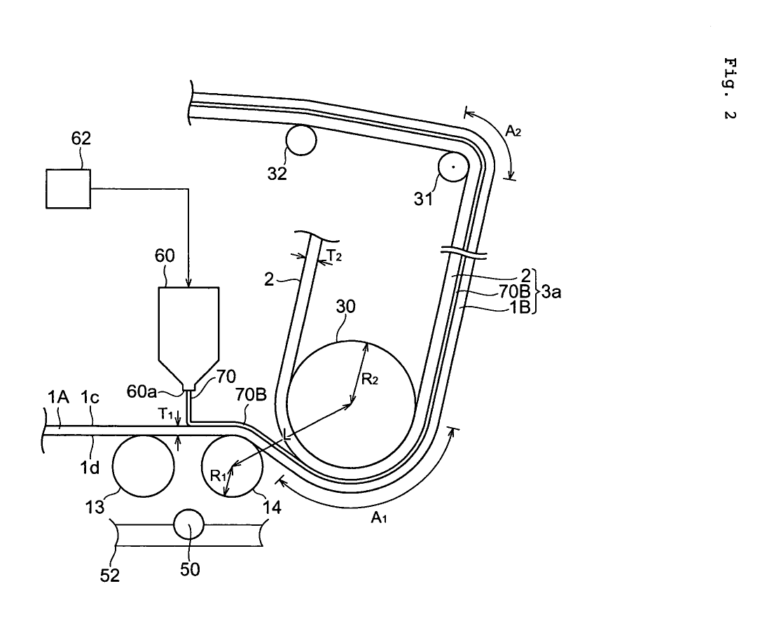

The first coating unit 65 has a cylindrical horizontal roller 13 and a feed roller 14 spaced in the horizontal direction and rotatable around a pair of mutually parallel horizontal axes, and the porous membrane 1 to be coated is applied to straddle between both upper ends of the horizontal roller 13 and the feed roller 14, and the porous membrane 1 is moved horizontally between the horizontal roller 13 and the feed roller 14. The first coating unit 65 also has a coating means (a slot die in the drawings) 60 for applying a polymer electrolyte solution 70 from above on the porous membrane 1 conveyed horizontally between the horizontal roller 13 and the feed roller 14. The slot die 60 is preferably, as shown in FIG. 2, disposed at a spacing above an opposite side 1c so that the opposite side 1c of a surface side 1d of the porous membrane 1 contacting with the horizontal roller 13 and the feed roller 14 may be the coat side (upside). The downside (non-coat side) of the porous membrane 1 directly contacts with the feed roller 14, so that the coating liquid, for example, the polymer electrolyte solution 70 may be prevented from sticking to the feed roller 14.

As shown in FIGS. 1 and 2, the slot die 60 has an opening 60a of a specified rectangular shape disposed at the lower end facing the porous membrane 1, extending in the width direction of the porous membrane 1. The slot die 60 forces out the coating liquid 70 supplied from the coating liquid feeder 62, such as a polymer electrolyte, by specified portions from the opening 60a, and spreads and applies on the coating side 1c of the porous membrane 1. As a result, as shown in FIG. 2, a coating liquid layer 70B is formed on the coating side 1c of the porous membrane 1. The supply pressure and the shape of the opening 60a are determined so that the thickness of the dried coating liquid 70 may be as specified. When a polymer electrolyte solution is used as the coating liquid, the polymer electrolyte solution layer 70B is reduced in thickness due to osmosis into the porous membrane 1, and the dried polymer electrolyte layer 70C (mentioned below) is further decreased in thickness, and it is preferred to apply in consideration of this phenomenon.

The amount of the polymer electrolyte solution layer 70B to be applied on the porous membrane 1 is, for example, the amount of the coating liquid containing at least the amount of the polymer electrolyte corresponding to the volume of voids in the porous membrane 1. The volume of voids in the porous membrane 1 can be calculated, for example, from the thickness of the membrane, coating area, apparent density, density of materials for composing the membrane, or the like.

After the coating liquid 70 is applied on the porous membrane 1 by the slot die 60, the porous membrane 1 coated with the coating liquid 70 is moved on the feed roller 14 along the circumferential surface, and supplied into the lamination roller 30. Before and after application of the coating liquid on the porous membrane 1, a plurality of horizontal rollers may be provided. In the invention, the feed roller is positioned at the end of the coating step, and supplies the porous membrane 1 coated with the coating liquid to the lamination roller to be described later, being positioned immediately before the lamination roller.

The lamination roller 30 is a rotating body of a cylindrical shape rotating about the horizontal axis, and laminates the supporting substrate 2 supplied from the guide roller 21, and the porous membrane 1 coated with the coating liquid supplied from the feed roller 14, and moves along the circumferential surface, thereby forming a laminate 3a by laminating the porous membrane 1 on the supporting substrate 2.

At this time, on the circumferential surface of the lamination roller 30, the supporting substrate 2 and the porous membrane 1 are preferably laminated so that the coat side 1c of the coating liquid 70 of the porous membrane 1 may be opposite to the supporting substrate 2, and that the porous membrane 1 may be positioned at the outer side of the axis of rotation of the lamination roller 30 rather than the supporting substrate 2. Herein, the coating liquid layer 70B contacts with the supporting substrate 2, and the supporting substrate 2 contacts with the circumferential surface of the lamination roller 30.

In the invention, as shown in FIG. 2, assuming the radius of the feed roller 14 is R1 (cm), the radius of the lamination roller 30 is R2 (cm), the distance between the central axes of the feed roller 14 and the lamination roller 30 is L (cm), the thickness of the porous membrane 1 is T1 (cm), and the thickness of the supporting substrate 2 is T2 (cm), a condition represented by the following expression (1) is satisfied.
R1+R2+T1+T2≦L≦R1+R2+100 (1)

In particular, the upper limit of L is preferably R1+R2+25, and more preferably R1+R2+15. Specifically, T1 is the thickness of the porous membrane 1 before application of the coating liquid, and T2 is the thickness before lamination with the porous membrane 1.

On the circumferential surface of the lamination roller 30, it is preferred that the central angle (embracing angle) A1 (degrees) of an arc contacting with the lamination roller 30 and the laminate 3a should satisfy a condition represented by the following expression (2).
10≦A1≦180 (2)

The central angle A1 (degrees) of the contacting arc of the lamination roller 30 and the laminate 3a is the central angle A1 (degrees) corresponding to the arc of the lamination roller 30, on the supporting substrate 2 moving on the circumferential surface of the lamination roller 30, from a point of the porous membrane 1 having the coating liquid layer 70B contacting with the porous membrane 1 to form a laminate 3a, to a point until the laminate 3a leaves the lamination roller 70B. A more preferable range of A1 is 30≦A1≦150.

Usually, the laminate 3a is supplied from the lamination roller to the guide roller. In FIG. 1, the guide rollers are 31 to 38. The guide rollers 31 to 38, as shown in FIG. 1, are rotating bodies having a cylindrical shape and rotating around the horizontal axis, and the laminate 3a supplied from the lamination roller 30 moves sequentially along the circumferential surface. The laminate 3a moves so that the supporting substrate 2 of the laminate 3a may be at the inner side, that is, the supporting substrate 2 may contact with the circumferential surface of the guide rollers 31 to 38. As a result, the coating liquid layer 70B is prevented from sticking to the rollers.

In the invention, the guide roller 31 on which the laminate 3a supplied from the lamination roller 30 moves in the first place may be called a conveying roller. Herein, it is preferred that the central angle (embracing angle) A2 (degrees) of an arc contacting with the circumferential surface of the guide roller 31 and the laminate 3a should satisfy a condition represented by the following expression (3).
10≦A2≦180 (3)
A more preferable range of A2 is 30≦A2≦150.

In the embodiment, the feed roller 14, the lamination roller 30, and the guide rollers 31 to 38 are movable in the running direction (X-direction) of the laminate and Y-direction vertical to the X-direction, and by adjusting the position of axis of rotation of each roller, the conditions of the above expressions (1) to (3) can be satisfied.

The drying unit 40 includes a plurality of dryers 40a for blowing hot air from the porous membrane 1 side of the laminate 3a guided by the guide rollers 31 to 38, and a plurality of dryers 40b for blowing hot air from the supporting substrate 2 side of the laminate 3a, and the laminate 3a is dried to form a laminate 3b. The conveying length in the drying unit 40 is, for example, about 5 to 20 m.

The drying unit 40 is not particularly limited as far as the solvent can be sufficiently removed from the laminate 3a, and may be realized either by an indirect heating system using microwave, high frequency wave, far infrared ray, steam, heating furnace or the like, or by a direct heating system using a heat transfer roll or the like. In particular, the indirect heating system by a hot air heater or a heating furnace is inexpensive in production and is preferred. The drying temperature may be a temperature with which the solvent can be sufficiently removed and the porous membrane 1 and the supporting substrate 2 are not deformed.

The take-up machine 80 has a bobbin 80a for winding up the dried laminate 3b, and the bobbin 80a is rotated at a specified speed to take up the laminate 3b. The take-up speed is somewhat different depending on the solvent, and is usually about 1 m/min.

The feeder 10 and the feeder 20 mentioned above rotate the bobbins 10a, 20a and send out the porous membrane 1 and the supporting substrate 2 respectively according to the winding operation of the take-up machine 80. In the feeder 10 and the feeder 20, by adjusting the rotating torque required to rotate these bobbins 10a, 20a, preferably, a desired tension F is applied to the porous membrane 1, or preferably to both the porous membrane 1 and the supporting substrate 2 in their conveying directions, in the coating step and/or the laminating step. In the embodiment, the feeders 10, 20 play the role of tension applying means, but the tension may be also applied by further disposing two or more rollers differing in peripheral speed in the coating step and/or the laminating step.

The tension F on the porous membrane 1 is preferably 0.01≦F (kg/cm)≦10 kg/cm, more preferably 0.05≦F≦2, and further preferably 0.1≦F≦1. If the tension F is lower than 0.01 or higher than 10, the suppressing effect of creasing or faulty appearance of the obtained laminate may be inferior.

The tension F to the supporting substrate is not particularly limited as far as it is strong enough to prevent loosening of the supporting substrate, and a tension below a breakdown level may be applied to laminate the porous membrane coated with a polymer electrolyte solution.

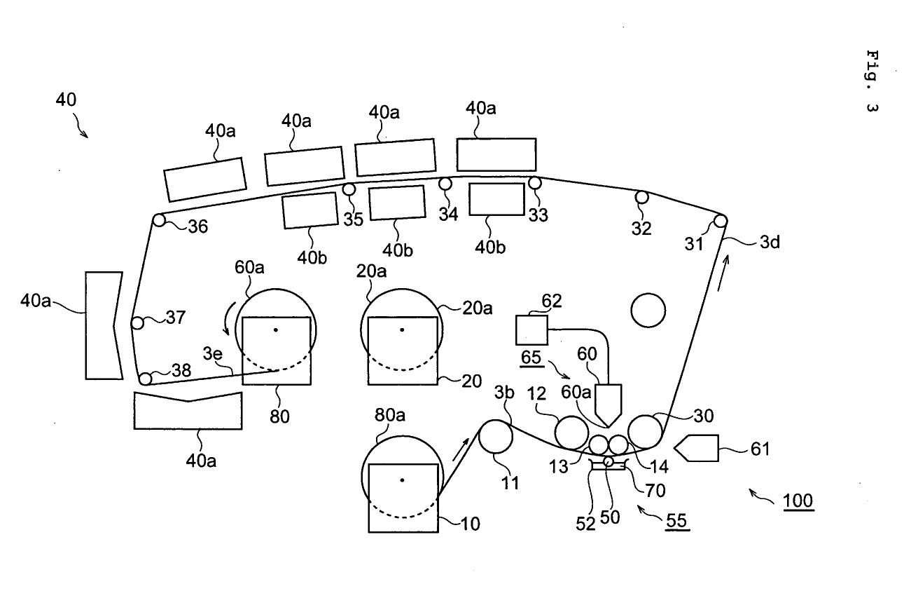

The apparatus 100 for production of the embodiment, as shown in FIG. 3, may also have a bobbin 80a taking up the dried laminate 3b mounted on the feeder 10. The feeder 10 can convey the dried laminate 3b to the lamination roller 30 by way of a second coating unit 55.

The second coating unit 55 shares the horizontal roller 13 and the feed roller 14 with the first coating unit 65. The horizontal roller 13 and the feed roller 14 can convey the dried laminate 3b to be coated horizontally by applying on both lower ends of each roller. Herein, the feeder 10 can supply the dried laminate 3b to the second coating unit 55 so that the supporting substrate 2 side may contact with the horizontal roller 13 and the feed roller 14. That is, the dried laminate 3b can be supplied to the second coating unit 55 so that the porous membrane 1 may face the lower side in the drawing.

The second coating unit 55 includes a gravure roll 50 for applying the polymer electrolyte solution 70 from beneath to the porous membrane 1 of the dried laminate 3b conveyed horizontally by the horizontal roller 13 and the feed roller 14, and a pan 52 for supplying the coating liquid 70 to the gravure roll 50. Instead of the second coating unit 55, a slot die 61 may be used to apply the polymer electrolyte solution 70 to the porous membrane 1 (see FIG. 3).

The laminate 3d further coated with the coating liquid 70 by the second coating unit 55 is guided by the lamination roller 30 and the guide rollers 31 to 38, and is taken up on the take-up machine 80 by way of the drying unit 40.

Herein, the lamination roller 30 and the guide rollers 31 to 38 contacting with the laminate 3d are designed to contact with the supporting substrate 2 side of the laminate 3d, thereby preventing the coating liquid layer 70B before drying from sticking to the rollers.

The porous membrane, the polymer electrolyte solution, the supporting substrate and the like used in the apparatus for production of the laminate are explained below.

(Porous Membrane)

The porous membrane used in the embodiment is a base material for applying a coating liquid containing a filler, and when a liquid containing a polymer electrolyte is used as the coating liquid, it is a base material for impregnating the polymer electrolyte, and it is used for enhancing the strength, flexibility, and durability as a polymer electrolyte.

The porous membrane is not particularly limited as far as the membrane is porous, and includes woven cloth, nonwoven cloth and the like, which may be used regardless of shape or material.

In particular, when used as a diaphragm of a solid polymer electrolyte type fuel cell, the thickness of the porous membrane is preferably 1 to 100 μm, more preferably 3 to 30 μm, and further preferably 5 to 20 μm. In this case, the pore size of the porous membrane is preferably 0.01 to 100 μm, and more preferably 0.02 to 10 μm. The void ratio of the porous membrane is preferably 20 to 98%, and more preferably 40 to 95%.

If the porous membrane is too thin, reinforcing effects for giving strength, flexibility or durability are insufficient, and gas leak (cross leak) is likely to occur. If the membrane is too thick, the electric resistance increases, and the obtained porous membrane impregnating a polymer electrolyte is insufficient as a diaphragm of a solid polymer type fuel cell. If the pore size is too small, it is hard to fill with a polymer solid electrolyte, or if too large, the reinforcing effect with the polymer solid electrolyte is weak. If the void ratio is too small, the resistance as a solid electrolyte membrane becomes large, or if too large, generally, the strength of the porous membrane itself becomes weak, and the reinforcing effect is decreased.

As the porous membrane, from the viewpoint of reinforcing effects of heat resistance and physical strength, it is preferred to use a membrane formed of an aliphatic polymer, an aromatic polymer, a polymer containing fluorine, or the like.

The aliphatic polymer includes, without limitation, polyethylene, polypropylene, polyvinyl alcohol, ethylene-vinyl alcohol copolymer, and many other examples. Herein, the polyethylene is a generic name of polymers containing a repetition unit derived from ethylene, and includes, in addition to straight chain high-density polyethylene (HDPE) and low-density polyethylene (LDPE), a copolymer of ethylene and other monomers, and specific examples are an ethylene-α-olefin copolymer called linear low-density polyethylene (LLDPE), ultra high molecular weight polyethylene, and the like. The polypropylene is a generic name of polymers containing a repetition unit derived from propylene, and includes a propylene block copolymer, a random copolymer (these are copolymers with ethylene or 1-butene, or the like), and the like. The aromatic polymer is, for example, polyester, polyethylene terephthalate, polycarbonate, polyimide, polysulfone, or the like.

The polymer containing fluorine includes a thermoplastic resin containing at least one carbon-fluorine bond in the molecule, and it is preferred to use a polymer with a structure in which all or majority of hydrogen atoms in the aliphatic polymer are replaced with fluorine atoms. Such examples include, without limitation, polytrifluoroethylene, polytetrafluoroethylene, polychlorotrifluoroethylene, poly (tetrafluoroethylene-hexafluoropropylene), poly (tetrafluoroethylene-perfluoroalkyl ether), and polyvinylidene fluoride. Especially, polytetrafluoroethylene and poly (tetrafluoroethylene-hexafluoropropylene) are preferred, and polytetrafluoroethylene is particularly preferred. The average molecular weight of these fluorine resins is preferably 100,000 or more from the viewpoint of mechanical strength.

(Filler and Coating Liquid)

The filler to be used in the embodiment is properly selected from the viewpoint of the purpose of use of the obtained laminate, demanded physical properties, and the like. When used as a diaphragm of a solid polymer electrolyte type fuel cell, the filler is preferably a polymer electrolyte. The polymer electrolyte includes ion exchange groups, for example, cation exchange groups such as —SO₃H, —COOH, —PO(OH)₂, —POH(OH), —SO₂NHSO₂—, -Ph(OH) (Ph represents phenyl group), and anion exchange groups such as —NH₂, —NHR, —NRR′, —NRR′R″⁺, —NH₃⁺ (R represents alkyl group, cycloalkyl group, aryl group, or the like), and a polymer soluble in a solvent is usually used. These groups may form a salt with a counter ion in part or in whole.

Representative examples of such polymer electrolyte include: (A) a polymer electrolyte having sulfonic acid group and/or phosphonic acid group introduced in a polymer of which principal chain is aliphatic hydrocarbon; (B) a polymer electrolyte having sulfonic acid group and/or phosphonic acid group introduced in a polymer in which hydrogen atoms in part or in whole of the principal chain are replaced with fluorine; (C) a polymer electrolyte having sulfonic acid group and/or phosphonic acid group introduced in a polymer of which principal chain has an aromatic ring; (D) a polymer electrolyte having sulfonic acid group and/or phosphonic acid group introduced in a polymer, such as polysiloxane or polyphosphagen, of which principal chain does not substantially contain a carbon atom; (E) a polymer electrolyte having sulfonic acid group and/or phosphonic acid group introduced in a copolymer consisting of two or more repetition units selected from repetition units composing the polymer before introduction of sulfonic acid group and/or phosphonic acid group in compounds (A) to (D); and (F) a polymer electrolyte containing a nitrogen atom in its principal chain or side chain, and having an acidic compound such as sulfuric acid or phosphoric acid introduced by ion bonding.

Examples of the polymer electrolyte of (A) include polyvinyl sulfonate, polystyrene sulfonate, and poly (α-methyl styrene) sulfonate.

Examples of the polymer electrolyte of (B) include polymers represented by Nafion (a registered trademark of E.I. du Pont de Nemours Company, hereinafter the same) having perfluoroalkyl sulfonic acid at the side chain and having perfluoroalkane as principal chain, sulfonic acid type polystyrene-graft-ethylene-tetrafluoroethylene copolymers (ETFE, for example, JP-A No. 9-102322) having a principal chain produced by copolymerization of a fluorocarbon vinyl monomer and a hydrocarbon vinyl monomer and a hydrocarbon side chain having sulfonic acid group, and sulfonic acid type poly (trifluorostyrene)-graft-ETFE membrane (for example, U.S. Pat. No. 4,012,303, U.S. Pat. No. 4,605,685) of a membrane produced by copolymerization of a fluorocarbon vinyl monomer and a hydrocarbon vinyl monomer, and produced as a solid polymer electrolyte membrane by graft-polymerizing α,β,β-trifluorostyrene, and introducing sulfonic acid group. Examples of the polymer electrolyte of (C) are not limited as far as the principal chain is interrupted by a hetero atom such as an oxygen atom, and include those having sulfonic acid group introduced in single polymers, such as polyether-ether ketone, polysulfone, polyether sulfone, poly (arylene ether), polyimide, poly ((4-phenoxy benzoyl)-1,4-phenylene), polyphenylene sulfide, and polyphenyl quinoxaline, and specific examples are sulfoarylated polybenzimidazole, sulfoalkylated polybenzimidazole, phosphoalkylated polybenzimidazole (for example, JP-A No. 9-110982), and phosphonated poly (phenylene ether) (for example, J. Appl. Polym. Sci., 18, 1969 (1974)).

Examples of the polymer electrolyte of (D) include polyphosphagen having sulfonic acid group introduced therein (see Polymer Prep., 41, No. 1, 70 (2000)) and polysiloxane having phosphonic acid group.

Examples of the polymer electrolyte of (E) include those having sulfonic acid group and/or phosphonic acid group introduced in a random copolymer, those having sulfonic acid group and/or phosphonic acid group introduced in an alternating copolymer, or those having sulfonic acid group and/or phosphonic acid group introduced in a block copolymer. Those having sulfonic acid group introduced in a random copolymer include a sulfonated polyether sulfone-hydroxy biphenyl copolymer (see, for example, JP-A No. 11-116779).

Examples of the polymer electrolyte of (F) include polybenzimidazole containing phosphoric acid disclosed in JP-A No. 11-503262. In the block copolymer contained in the polymer electrolyte of (E), specific examples of the block having sulfonic acid group and/or phosphonic acid group are the blocks having sulfonic acid group and/or phosphonic acid group disclosed, for example, in JP-A No. 2001-250567. The weight-average molecular weight of the polymer electrolyte used in the invention is usually about 1000 to 1000000, and the ion exchange group equivalent weight is usually about 500 to 5000 g/mol.

Among the polymer electrolytes in (A) to (F), a particularly preferred example is a polymer electrolyte having sulfonic acid group and/or phosphonic acid group introduced in the polymer having an aromatic ring in the principal chain of (C). The polymer electrolyte may contain additives used in polymers, such as plasticizer, stabilizer, and parting agent, within a scope not departing from the true spirit of the invention.

In the invention, the solution of such polymer electrolyte dissolved in a solvent, that is, a polymer electrolyte solution is used as the coating liquid.

The solvent is not particularly limited as far as a polymer electrolyte can be dissolved and it can be removed after the process, and examples include aprotic polar solvents such as N,N-dimethyl formamide, N,N-dimethyl acetamide, N-methyl-2-pyrrolidone, and dimethyl sulfoxide, chlorine solvents such as dichloromethane, chloroform, 1,2-dichloroethane, chlorobenzene, and dichlorobenzene, alcohols such as methanol, ethanol, and propanol, and alkylene glycol monoalkyl ethers such as ethylene glycol monomethyl ether, ethylene glycol monoethyl ether, propylene glycol monomethyl ether, and propylene glycol monoethyl ether. They may be used either alone, or in combination of two or more solvents if necessary. In particular, dimethyl acetamide, dichloromethane-methanol mixed solvent, dimethyl formamide, and dimethyl sulfoxide are preferred because the solubility is high.

The coating liquid in the invention has a viscosity η (cps: centipoise) usually in the range of 5≦η≦5000.

The viscosity is the value measured at a relative humidity of 50% by using a BL type viscometer (manufactured by Tokyo Keiki co., Ltd.), and the thickness precision is lowered if it is less than 5 or more than 5000. If the thickness precision is not sufficient, stress may be concentrated in the thinner area, and the membrane is likely to be broken, and hence the viscosity is preferably in the specified range.

Preferably, the viscosity η of the coating liquid is 30≦η≦5000, more preferably 100≦η≦3000, and most preferably 300≦η≦2500.

In the coating liquid, the concentration C (wt. %) of the polymer electrolyte is preferably in a range of about 1≦C≦50. If the concentration is less than the specified range, impregnation into voids of the porous membrane is insufficient when dried, or if it is more than the specified range, the viscosity tends to be too high, and sometimes it may be hard to control the coating thickness. A more preferred range of the concentration C is about 6≦C≦35.

When the contact angle of the coating liquid with the coat side of the porous membrane is 90 degrees or less, an effect is caused that the polymer electrolyte solution is sucked in by a capillary action, and the voids in the porous membrane tend to almost completely filled with the coating liquid. Therefore, in such a case, by using at least a required amount of coating liquid, and by applying and drying on the porous membrane, the voids in the porous membrane are almost completely impregnated with the polymer electrolyte, so that a complex of the porous membrane and the polymer electrolyte may be obtained easily.

(Supporting Substrate)

The supporting substrate to be laminated on the porous membrane is not particularly limited as far as it is not swollen or dissolved by the coating liquid, and depending on the application, it is preferred to use a supporting substrate allowing the porous membrane to be peeled off from the laminate obtained after lamination. More preferably, a supporting substrate deformable together with the porous membrane is desired, and when used as a diaphragm of a solid polymer electrolyte type fuel cell, it is preferred to use a sheet composed of a polymer not having an ion exchange group other than the polymer electrolyte stated above. Examples of the sheet composed of a polymer not having an ion exchange group include polyolefin resins represented by polyethylene or polypropylene, and sheets made of polystyrene (PS), polycarbonate (PC), and polyethylene terephthalate (PET). The supporting substrate may be processed as required, by a parting process, mirror smooth finishing process, embossing process, mat process, or the like.

When using the polymer electrolyte porous membrane as an electrolyte membrane for a fuel cell (MEA) bonded with an electrode, use of carbon fabric or carbon paper preliminarily coated with a solvent to be used as an electrode as a supporting substrate is preferable because the process of separating the supporting substrate and the multilayer polymer electrolyte, or the process of electrode bonding can be omitted.

Thickness of the supporting substrate used in the invention is about 20 to 300 μm, for example.

(Process for Production)

A preferred example of the process for production of a laminate using the apparatus 100 for production of the embodiment is explained. In the following process for production, a polymer electrolyte solution is used as the coating liquid, but the same effects are obtained by using a liquid containing other filler as the coating liquid.

In the embodiment, as shown in FIG. 1, while a specified pressure is applied on the porous membrane and the supporting substrate, a dried laminate 3b is produced in the continuous and sequential operation of the coating step, laminating step, conveying step, and drying step, the dried laminate 3b is take up on the bobbin 80a, which is mounted on the feeder 10, and a dried laminate 3e is obtained as shown in FIG. 3.

As shown in FIG. 2, a polymer electrolyte solution 70 is applied o the coat side 1c of the porous membrane 1 supplied from the feeder 10, and a polymer electrolyte solution layer 70B is formed on the porous membrane 1 (coating step).

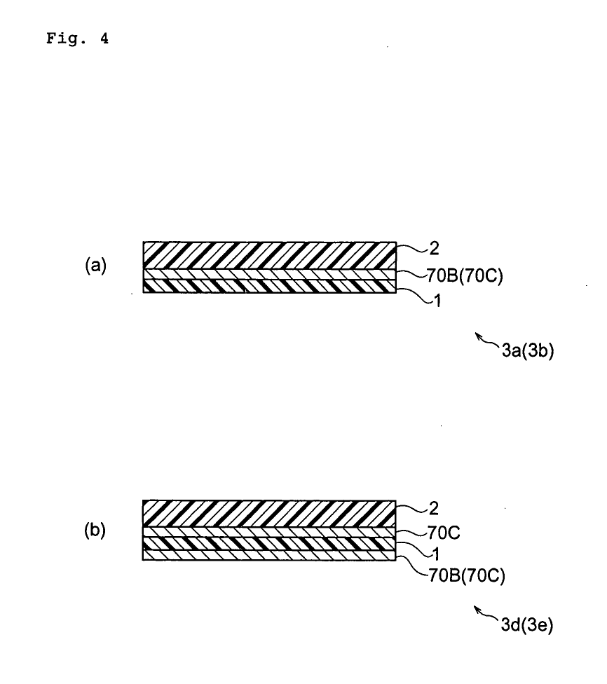

Next, in the laminating step, the supporting substrate 2 is supplied to the lamination roller 30, and the porous membrane 1 coated with the polymer electrolyte solution 70 is moved on the circumferential surface of the feed roller 14, and supplied to the lamination roller 30. On the lamination roller 30, the porous membrane 1 coated with the polymer electrolyte solution 70 and the supporting substrate 2 are laminated, and a laminate 3a is formed (laminating step). The laminate 3a is a polymer electrolyte composite membrane having a structure of (supporting substrate 2/polymer electrolyte solution layer 70B/porous membrane 1) (see FIG. 4(a)). The polymer electrolyte solution 70 is impregnated in the voids of the porous membrane 1.

The laminate 3a laminated on the lamination roller 39 is moved along the circumferential surface of the guide rollers 31 and the like, and guided and conveyed into the drying unit 40 (conveying step).

While the laminate 3a conveyed by the guide rollers 31, 32 is further conveyed by the guide rollers 33 to 36, the laminate 3a is passed into the drying unit 40, and the laminate 3a is dried (drying step).

At the laminating step, the solvent in the polymer electrolyte solution 70 is removed. Therefore, the polymer electrolyte solution layer 70B becomes a polymer electrolyte layer 70C, and the polymer electrolyte solution in the voids of the porous membrane 1 also becomes a polymer electrolyte. As a result, a dried laminate 3b is formed. The laminate 3b is a polymer electrolyte composite membrane having a structure of (supporting substrate 2/polymer electrolyte layer 70C/porous membrane 1), having the dried polymer electrolyte layer 70C and the dried porous membrane 1 impregnated with the polymer electrolyte in the voids laminated in this sequence on the supporting substrate 2 (see FIG. 4(a)). Such dried laminate 3b is taken up on the bobbin 80a of the take-up machine 80.

Successively, as shown in FIG. 3, the bobbin 80a taking up this laminate 3b is mounted on the feeder 10, and while a desired pressure is applied to the dried laminate 3b, the dried laminate 3b is applied between both lower ends of the horizontal roller 13 and the feed roller 14 so that the layer 1B of the dried porous membrane may come to the lower side, and is further conveyed to the latter stage by way of the lamination roller 30. On the surface of the porous membrane 1 of the dried laminate 3b, the polymer electrolyte solution 70 is applied from the gravure roll 50 of the second coating unit 55, and the polymer electrolyte solution layer 70B is formed to obtain a laminate 3d. This laminate 3d is a polymer electrolyte composite membrane having a structure of (polymer electrolyte solution layer 70B/porous membrane 1/polymer electrolyte layer 70C/supporting substrate 2) (see FIG. 4(b)).

The laminate 3d coated with the solution is further dried by the drying unit 40, and the polymer electrolyte solution layer 70B becomes the polymer electrolyte layer 70C, and a laminate 3e is formed. This laminate 3e is a polymer electrolyte composite membrane having a structure of (polymer electrolyte layer 70C/porous membrane 1/polymer electrolyte layer 70C/supporting substrate 2) (see FIG. 4(b)).

The polymer electrolyte composite membrane is used by optionally stripping off the supporting substrate when used in a fuel cell. The thickness of the polymer electrolyte composite membrane is usually about 5 to 200 μm, preferably about 10 to 100 μm, and more preferably about 15 to 80 μm.

In the embodiment, the radius R1 of the feed roller 14, the radius R2 of the lamination roller 30, the distance L between the central axes of the feed roller 14 and the lamination roller 30, the thickness T1 of the porous membrane 1, and the thickness T2 of the supporting substrate 2 satisfy the condition represented by expression (1) above, and the distance between the feed roller 14 and the lamination roller 30 is sufficiently short. As a result, between the feed roller 14 and the lamination roller 30, swelling or loosening of the porous membrane 1 coated with the polymer electrolyte solution 70 is sufficiently suppressed, and the porous membrane 1 and the supporting substrate 2 are overlaid and laminated in this state. As a result, creasing of the porous membrane 1 on the laminates 3a, 3b, and the like can be suppressed.

In the lamination roller 30, when the laminate 3a is moved along the circumferential surface of the lamination roller 30 so that the supporting substrate 2, instead of the porous membrane 1, may be positioned at the inner side, the porous membrane 1 is particularly stretched in the circumferential direction of the lamination roller 30 on the circumferential surface of the lamination roller 30, and the suppressing effect of creasing of the porous membrane 1 is further enhanced.

In particular, when the central angle of an arc contacting with the lamination roller 30 and the laminate 3a satisfies the condition of the expression (2), at the laminating step, the laminate 3a is sufficiently pressed against the lamination roller 30, and the porous membrane 1 is stretched sufficiently in the conveying direction, and creasing of the porous membrane 1 on the laminate 3a can be further suppressed.

After lamination by the lamination roller 30, when the laminate 3a is moved along the circumferential surface of the conveying roller 31 so that the porous membrane 1, rather than the supporting substrate 2, may come to the outer side, the porous membrane 1 is further stretched particularly in the circumferential direction of the guide roller 31 on the circumferential surface of the guide roller 31, so that the suppressing effect of creasing of the porous membrane 1 may be further enhanced.

Since the central angle of the contacting arc of the guide roller 31 and the laminate 3a satisfies the condition of the expression (3), same as mentioned above, the laminate 3a is sufficiently pressed against the circumferential surface of the guide roller 31. As a result, the porous membrane 1 is further stretched in the conveying direction, and creasing of the porous membrane 1 on the laminate 3a can be further suppressed.

When the porous membrane 1 and the supporting substrate 2 are laminated while applying the specified tension F mentioned above in the conveying direction, the porous membrane 1 coated with the polymer electrolyte solution is laminated with the supporting substrate 2 in a less creasable state, and the suppressing effect of creasing may be further enhanced.

The porous membrane containing the polymer electrolyte thus formed can be preferably applied, for example, in the following fuel cell.

This fuel cell is a unit cell composed of a membrane electrode bonded structure consisting of an anode and a cathode as gas diffusion electrodes disposed oppositely to each other, and a polymer electrolyte membrane interposed in contact with the both electrodes and passing ions selectively, and a plurality of such unit cells are laminated alternately by way of a separator having a gas distributing means. In this fuel cell, by making use of an electrochemical reaction occurring by supplying a fuel such as hydrogen, reformed gas or methanol to the anode, and an oxidizing agent such as oxygen to the cathode, the fuel is oxidized catalytically, while the oxidizing agent is reduced catalytically at the same time, and this chemical reaction energy is directly converted into an electrical energy, and power is generated.

The catalyst is not particularly limited, and any known material may be used as far as oxidation-reduction reaction with hydrogen or oxygen can be activated, and platinum fine particles are particularly preferred. Preferably, platinum fine particles are often carried on granular or fibrous carbon such as active carbon or graphite.

Conductive substances as a current collector may be any known material, and porous carbon fabric or carbon paper is preferred for conveying the material gas efficiently to the catalyst.

Various known methods of bonding platinum fine particles or carbon carrying platinum fine particles to porous carbon fabric or carbon paper, and of bonding it to a polymer electrolyte sheet are described in publications including, for example, J. Electrochem. Soc.: Electrochemical Science and Technology, 1988, 135 (9), 2209.

### Second Embodiment

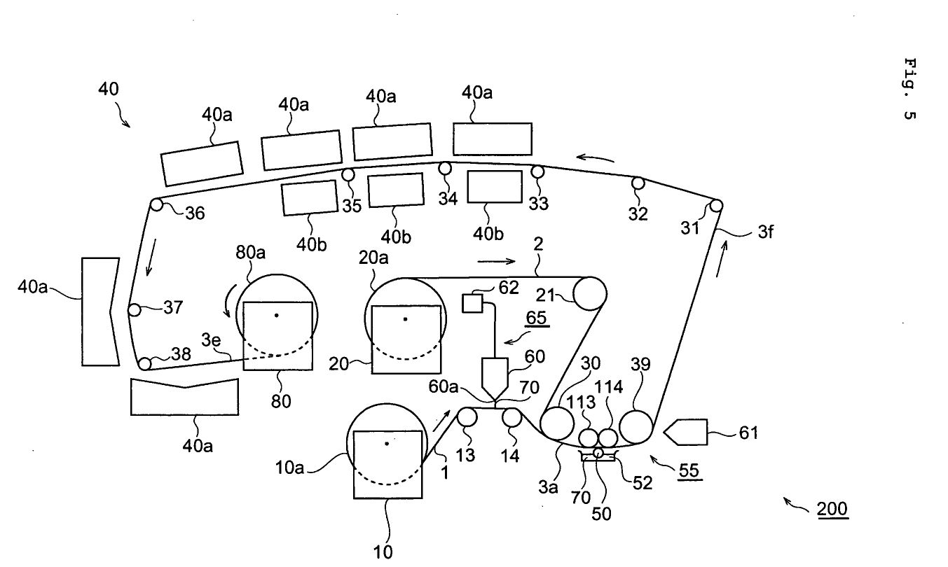

The apparatus 200 for production of the embodiment (see FIG. 5) is different from the apparatus 100 for production in the first embodiment only in that a second coating unit 55 is provided, and the second coating unit 55 is intended to apply a coating liquid 70 to an undried laminate 3a after lamination by a lamination roller 30. Instead of the second coating unit 55, a slot die 61 may be used for applying the coating liquid 70.

Specifically, the second coating unit 55 has a pair of horizontal rollers 113, 114 for conveying the laminate 3a formed by the lamination roller 30 horizontally by stretching between the both lower ends. These horizontal rollers 113, 114 are provided independently of the horizontal roller 13 and the feed roller 14 of the first coating unit 65.

The gravure roller 50 applies the coating liquid 70 from the underside to the laminate 3a conveyed horizontally by the horizontal rollers 113, 114, and a laminate 3f coated with the coating liquid 70 on both sides of the porous membrane 1 is formed.

According to such apparatus 200 for production, since a coating liquid 70 such as a polymer electrolyte solution is applied also on the opposite side 1d of the porous membrane 1 (see FIG. 2) by the gravure roll 50, it is easy to produce a laminate 3f having a structure of (polymer electrolyte solution layer 70B/porous membrane 1/polymer electrolyte solution layer 70B/supporting substrate 2) in a single process of drying. Further, after forming the laminate 3a including the supporting substrate 2, the coating liquid 70 is applied to the opposite side 1d of the porous membrane 1, and the creasing suppressing effect to the layer 1 of the porous membrane is higher as compared with the case of applying the coating liquid 70 on both sides of the porous membrane 1 before forming the laminate 3a.

The preferred embodiments of the process for production and the apparatus for production of the laminate of the embodiment are described above, but the invention is not limited to the foregoing embodiments alone.

For example, in the foregoing examples, the slot die 60 is used for applying the polymer electrolyte solution 70 to the porous membrane 1, but it is not limited as far as a desired coating membrane thickness can be achieved, and other examples include methods using a roll coater, comber coater, doctor blade, lip coater, wire bar, gravure coater, bar coater or the like, a method of applying a coating liquid by immersion of the porous membrane in a coating liquid, a method of adjusting the thickness by passing through a gap set at a desired clearance after immersing in a coating liquid, and others.

The coating method by the gravure roll 50 in the above embodiments may be replaced by a slot die or other coating methods which are mentioned above.

In the above embodiments, when laminating the supporting substrate 2 on the porous membrane 1 coated with the coating liquid 70 on one side, the supporting substrate is laminated on the coating liquid applied side of the porous membrane 1, but the supporting substrate may also be laminated on the opposite side of the coating liquid 70 applied side of the porous membrane 1. Alternately, the supporting substrate 2 may be preliminarily coated with the coating liquid on its surface. In this case, the side of the porous membrane to be laminated with the supporting substrate 2 may either be coated with or not coated with the coating liquid, but preferably may not be coated.

Alternatively, an opposite roller (not supplying supporting substrate 2) set at a desired clearance may be disposed in the lamination roller 30, and the porous membrane 1 coated with the coating liquid and the supporting substrate 2 may be laminated by passing between the lamination roller 30 and the opposite roller.

Between the lamination roller 30 and the guide roller 31, a so-called crown roller may be provided. In this case, when the laminate 3a moves on the circumferential surface of the crown roller, the porous membrane is further stretched in the width direction, and a further creasing suppressing effect is obtained. The creasing suppressing effect is also high when the guide roller 31 and the guide roller 32 are disposed so that the laminate 3a may draw an arch.

In the above embodiments, the polymer electrolyte solution is applied on both sides of the porous membrane 1 as a coating liquid, and polymer electrolyte layers are formed on both sides, but it goes without saying that it may be also applied on one side only.

In the above embodiments, one porous membrane 1 is used, but after lamination of the porous membrane 1 coated with the coating liquid and the supporting substrate 2, as required, other porous membranes may be preferably laminated, or other porous membranes preliminarily coated with the coating liquid may be preferably laminated, and such lamination can also be realized by the same method.

When a polymer electrolyte solution is used as the coating liquid, if the polymer electrolyte is not impregnated deeply into the voids of the porous membrane after drying, or when desired to form another electrolyte layer in the outermost layer, the polymer electrolyte solution can be preferably applied and dried again after the drying step.

The basic layer composition of the obtained laminate (polymer electrolyte composite membrane) includes, for example, (porous membrane containing polymer electrolyte/polymer electrolyte layer/supporting substrate), (polymer electrolyte layer/porous membrane containing polymer electrolyte/supporting substrate), and (polymer electrolyte layer/porous membrane containing polymer electrolyte/polymer electrolyte layer/supporting substrate). In the invention, by combining these layer structures, it is also preferred to form (polymer electrolyte layer/porous membrane containing polymer electrolyte layer/polymer electrolyte layer/porous membrane containing polymer electrolyte layer/supporting substrate), or the like. The polymer electrolyte composite membrane as such laminate is used by stripping off the supporting substrate when used in a fuel cell. Thickness of the laminate is usually about 5 to 200 μm, preferably about 10 to 100 μm, and more preferably about 15 to 80 μm.

As the coating liquid, that is, a liquid containing a filler, liquids containing various fillers may be used depending on the purposes. For example, to fill in the voids of the porous membrane, the filler may be an organic material or an inorganic material other than the polymer electrolyte. Such filler may be dissolved in the solvent and used as a coating liquid, or when the filler is particles that can be put in the voids the porous membrane 1, such filler particles may be dispersed in a liquid, and its slurry may be used as a coating liquid.

As the organic material of the filler, either a low molecular weight compound or a high molecular weight compound may be used.

The low molecular weight compound is not particularly limited and any compound may be used preferably if handling of a membrane state is possible when applied in the voids of the porous membrane even if it is hard to form a membrane by itself. Examples of such compound include (meth)acrylic acid esters such as (meth)acrylic acid, methyl (meth)acrylate, ethyl (meth)acrylate, and (meth)acrylic acid 2-ethyl hexyl; styrene derivatives such as styrene, divinyl benzene, vinyl toluene, and α-methyl styrene; vinyl ethers such as methyl vinyl ether, ethyl vinyl ether, and cyclohexyl vinyl ether; vinyl esters such as vinyl acetate, vinyl propionate, and vinyl cinnamate; acrylamides such as N-tert butyl acrylamide, and N-cyclohexyl acrylamide, and methacrylic amides, and acrylonitrile derivatives.

In the case of the low molecular weight compound, by filling the porous membrane with it and its mixture with a reaction initiator, the porous membrane may be filled with a high molecular weight compound by performing polymerization reaction or crosslinking reaction. The low molecular weight compound preferably applicable to such method includes, in addition to the low molecular weight compounds given above, a composition of phenols and formaldehyde or acetaldehyde, vinylsulfonic acid, vinyl phosphonic acid, and the like. The reaction initiator includes azoisobutyronitrile and the like. When forming a high molecular weight compound in the porous membrane by crosslinking reaction or the like, the methods include crosslinking reaction in a constituent unit obtained by preliminary polymerization of a monomer having a self-crosslinking functional group in a molecule such as glycidyl(meth)acrylate and glycidyl vinyl ether; crosslinking reaction in a constituent unit obtained by polymerization of a monomer having carboxyl group, hydroxy group, amino group, or sulfo group (for example, (meth)acrylic acid, methylol(meth)acrylate, hydroxy alkyl(meth)acrylate, allyl acrylate, hydroxy ethyl vinyl ether, hydroxy butyl vinyl ether, maleic acid, crotonic acid); and crosslinking reaction in a constituent unit having a crosslinking reactive group such as (meth)acryloyl group introduced in these constituent units by polymer reaction (for example, introduced by an action of chloride acrylate on hydroxy group).

The high molecular weight compound is not particularly limited and includes, for example, aliphatic polymers polyethylene, polypropylene, polyvinyl alcohol, ethylene-vinyl alcohol copolymer, polytetrafluoro ethylene, polychloro trifluoroethylene, cellulose and the like, and crosslinking reaction of aromatic polymers such as polyethylene terephthalate, polycarbonate, polyimide, polystyrene, polyallylate, polysulfone, polyether-ether ketone and the like.

The inorganic material of the filler is not particularly limited, and examples include ceramic particles such as alumina, silica, silicon nitride and the like, metal particles such as silver, copper, aluminum, nickel and the like, pigments, and others, and several types of them may be combined. Specific application examples are disclosed in JP-A No. 10-72534, including heat releasing materials such as metals including aluminum, silver, copper, nickel, tin and the like, alloys including pure aluminum for industrial use, corrosion resistant aluminum, super aluminum, brass, Ni steel, Cr steel and the like, and inorganic materials including aluminum oxide, magnesium oxide, silicon carbide and the like, and by dispersing them in a solvent to fill in the voids of the porous membrane, and by distilling off the solvent, a heat releasing material is obtained.

The invention is described by referring to examples below, but it should be noted that the invention is not limited to these examples alone.

<Porous Membrane and Supporting Substrate>

The porous membrane was a polyethylene porous film (thickness (T1) 11 μm, width 28 cm, porosity 57%), and the supporting substrate was polyethylene terephthalate (PET) manufactured by Toyobo Co., Ltd. (trade name E5000: thickness (T2) 100 μm, width 30 cm).

<Polymer Electrolyte Solution>

Conforming to the method of JP-A No. 2001-250567, a block copolymer of polyether sulfone segment and poly (2-phenyl-1,4-phenylene oxide) segment was synthesized and sulfonated.

The obtained sulfonated block copolymer was dissolved in N,N-dimethyl acetamide and the concentration of the solution was adjusted to 20 weight %, and a polymer electrolyte solution was prepared. The viscosity of the solution was 2000 cps when measured with a BL viscometer manufactured by Tokyo Keiki Co., Ltd.

<Apparatus for Production>

In the embodiment, using the apparatus for production shown in FIGS. 1 to 3, the laminate was produced as described in the first embodiment. Herein, the radius (R1) of the feed roller 14 was 1.5 cm, the radius (R2) of the lamination roller 30 was 3.5 cm, and the tension F applied to the porous membrane and the supporting substrate in the conveying direction was 0.22 kg/cm.

In this apparatus for production, by adjusting the positions of these rollers, the central angle (embracing angle) of the arc with which the laminate contacts can also be adjusted. The conditions were determined individually in Examples and Comparative Examples.

### Example 1

The apparatus for production was set in the condition of a central distance (L) of the feed roller 14 and the lamination roller 30=8 cm, a central angle (embracing angle) (A1) of the contacting arc of the lamination roller 30 and the laminate=35 degrees, and a central angle (embracing angle) (A2) of the contacting arc of the first guide roller 31 and the laminate=62 degrees. Therefore, the spacing of the lamination roller 30 and the feed roller 14 is L−(R1+R2)=3 cm.

In succession, as mentioned above, the polymer electrolyte solution was applied on the porous membrane, and laminated on the supporting substrate to give a laminate, and this laminate was dried. The thickness of the polymer electrolyte solution layer before drying was about 0.1 mm.

On the opposite side of the porous membrane, further, the polymer electrolyte solution was applied by using a slot die, dried, and a polymer electrolyte composite membrane (laminate 3e) of Example 1 was obtained in a structure of (polymer electrolyte layer/porous membrane/polymer electrolyte layer/supporting substrate). The thickness of the polymer electrolyte composite membrane after drying was 138 μm.

<Evaluation of Appearance of Polymer Electrolyte Composite Membrane>

In a size of 20 cm×20 cm, a sample (a) was cut out from the central area of the polymer electrolyte composite membrane, and samples (b) to (f) in a size of 20 cm×20 cm each were cut out from the central area at the same position as the first sample, at positions apart by 2 m, 4 m, 6 m, 8 m, and 10 m in the take-up direction from the initial cutting position. In a composite membrane sample of a total of six pieces, the supporting substrate was stripped off, and the number of creases visually recognized in the composite membrane was counted. The higher this value is, the poorer the appearance is, and the lower the value is, the better the appearance is. The results of the evaluation are shown in Table 1.

### Comparative Example 1

A polymer electrolyte composite membrane (laminate) of Comparative Example 1 was obtained in the same manner as in Example 1, except that the apparatus for production was set in the following condition. The results of the evaluation are shown in Table 1.

The condition was set in a central distance (L) of the feed roller 14 and the lamination roller 30=115 cm, a central angle (embracing angle) (A1) of the contacting arc of the lamination roller 30 and the laminate=5 degrees, and a central angle (embracing angle) (A2) of the contacting arc of the guide roller (conveying roller) 31 and the laminate=90 degrees. Therefore, the spacing of the lamination roller 30 and the feed roller 14 is L−(R1+R2)=110 cm. The results of evaluation are shown in Table 1.

In Example 1, as compared with Comparative Example 1, creasing of the porous membrane was sufficiently suppressed.

TABLE 1

Sample

| | a | b | c | d | e | f |
|---|---|---|---|---|---|---|
| Example 1 | 0 | 0 | 0 | 0 | 1 | 0 |
| Comparative | 4 | 1 | 8 | 11 | 9 | 7 |
| Example 1 | | | | | | |

### INDUSTRIAL APPLICABILITY

The invention hence provides a process for production and an apparatus for production of a laminate in which creasing is suppressed.

1. A process for production of a laminate comprising:
a coating step for coating a porous membrane with a coating liquid, and
a laminating step for moving the porous membrane coated with the coating liquid along the circumferential surface of a feed roller, moving the porous membrane coated with the coating liquid along the circumferential surface of a lamination roller together with a supporting substrate, and laminating the porous membrane coated with the coating liquid and the supporting substrate to obtain a laminate,
wherein assuming the radius of the feed roller is R1 (cm), the radius of the lamination roller is R2 (cm), the distance between the central axes of the feed roller and the lamination roller is L (cm), the thickness of the porous membrane is T1 (cm), and the thickness of the supporting substrate is T2 (cm), a condition represented by the following expression (1) is satisfied.
R1+R2+T1+T2≦L≦R1+R2+100 (1)

2. The process for production of a laminate of claim 1, wherein the laminate is formed so that the porous membrane coated with the coating liquid, rather than the supporting substrate, may come to the outer side on the circumferential surface of the lamination roller.

3. The process for production of a laminate of claim 2, wherein the central angle A1 (degrees) of an arc contacting with the lamination roller and the laminate satisfies a condition represented by the following expression (2).
10≦A1≦180 (2)

4. The process for production of a laminate of claim 1, wherein the laminating step is further followed by a conveying step for moving the laminate along the circumferential surface of the conveying roller so that the porous membrane may come to the outer side.

5. The process for production of a laminate of claim 4, wherein the central angle A2 (degrees) of an arc contacting with the conveying roller and the laminate satisfies a condition represented by the following expression (3).
10≦A2≦180 (3)

6. The process for production of a laminate of claim 1, wherein in the coating step and the laminating step, a tension F (kg/cm) is applied to satisfy a condition represented by the following expression (4) to the porous membrane in its conveying direction.
0.01≦F≦10 (4)

7. The process for production of a laminate of claim 1, wherein the coating liquid is a liquid containing a polymer electrolyte.

8. An apparatus for production of a laminate comprising:
a coating means for coating a porous membrane with a coating liquid,
a feed roller for moving the porous membrane coated with the coating liquid along the circumferential surface, and
a lamination roller for moving the porous membrane after moving along the circumferential surface of the feed roller along the circumferential surface together with a supporting substrate, and laminating the porous membrane and the supporting substrate to obtain a laminate,
wherein assuming the radius of the feed roller is R1 (cm), the radius of the lamination roller is R2 (cm), the distance between the central axes of the feed roller and the lamination roller is L (cm), the thickness of the porous membrane is T1 (cm), and the thickness of the supporting substrate is T2 (cm), a condition represented by the following expression (1) is satisfied.
R1+R2+T1+T2≦L≦R1+R2+100 (1)

9. The apparatus for production of a laminate of claim 8, wherein the central angle A1 (degrees) of an arc contacting with the lamination roller and the laminate satisfies a condition represented by the following expression (2).
10≦A1≦180 (2)

10. The apparatus for production of a laminate of claim 8, further comprising a conveying roller for moving the laminate formed by the lamination roller along the circumferential surface so that the porous membrane may come to the outer side.

11. The apparatus for production of a laminate of claim 10, wherein the central angle A2 (degrees) of an arc contacting with the conveying roller and the laminate satisfies a condition represented by the following expression (3).
10≦A2≦180 (3)

12. The apparatus for production of a laminate of claim 8, further comprising a tension applying means for applying a tension F (kg/cm) to satisfy a condition represented by the following expression (4) to the porous membrane in its conveying direction.
0.01≦F≦10 (4)
